(19) United States
(12) Patent Application Publication
(10) Pub. No.: US 2012/0326495 A1
(43) Pub. Date: Dec. 27, 2012

(54) ABS HYDRAULIC UNIT WITH ACCUMULATOR

(75) Inventor: Vern Trageser, Mt. Pleasant, SC (US)

(73) Assignee: ROBERT BOSCH GMBH, Stuttgart (DE)

(21) Appl. No.: 13/168,511

(22) Filed: Jun. 24, 2011

(51) Int. Cl. B60T 8/36; B60T 8/176

(52) U.S. Cl. 303/119.2

(57) ABSTRACT

An anti-lock braking hydraulic unit for a vehicle includes a body with actuator-side and brake-side ports. Inlet and outlet valves are positioned in the body and operable to selectively supply and relieve hydraulic fluid to/from the wheel cylinder of a brake via the brake-side port. An accumulator is fluidly coupled with the outlet valve to receive hydraulic fluid relieved from the wheel cylinder. The accumulator includes a bore formed in the body and an orifice formed in the body in fluid communication with the bore. The orifice is positioned at a first end of the bore, and a closure is sealingly engaged with a second end. A piston is sealingly received in the bore, movable within the bore along an axis defined thereby and dividing the bore into first and second variable volume chambers. At least one ferromagnetic pair magnetically biases the piston toward the first end of the bore.

### BACKGROUND

The present invention relates to anti-lock braking system (ABS) hydraulic units for vehicles. More particularly, the invention relates to ABS hydraulic unit accumulators. In order to accommodate the various requirements for accumulators of different volumetric capacities corresponding to different vehicle needs, it is generally required for a supplier to produce ABS hydraulic units with accumulators constructed of various combinations of pistons, coil springs, and covers.

### SUMMARY

In one aspect, the invention provides an anti-lock braking hydraulic unit for a vehicle. A body of the hydraulic unit includes at least one actuator-side port configured to be fluidly coupled with a master cylinder, and at least one brake-side port configured to be fluidly coupled with a wheel cylinder of a braking device. An inlet valve is positioned in the body and operable between an open condition and a closed condition, the inlet valve being configured to direct hydraulic fluid from the actuator-side port to the wheel cylinder via the at least one brake-side port when the inlet valve is in the open condition. An outlet valve is positioned in the body and operable between an open condition and a closed condition, the outlet valve being configured, when in the open condition, to relieve hydraulic fluid from the wheel cylinder via the at least one brake-side port. An accumulator is fluidly coupled with the outlet valve to receive hydraulic fluid relieved from the wheel cylinder by the outlet valve. The accumulator includes a bore formed in the body and having first and second ends, an orifice formed in the body in fluid communication with the bore and positioned at a first end of the bore, and a closure sealingly engaged with the second end of the bore. A piston is positioned in the bore and forms a seal therewith, the piston being movable within the bore along an axis defined thereby and dividing the bore into first and second variable volume chambers. At least one ferromagnetic pair magnetically biases the piston toward the first end of the bore.

In another aspect, the invention provides an anti-lock braking hydraulic unit for a vehicle. A body of the hydraulic unit includes at least one actuator-side port configured to be fluidly coupled with a master cylinder, and at least one brake-side port configured to be fluidly coupled with a wheel cylinder of a braking device. An inlet valve is positioned in the body and operable between an open condition and a closed condition, the inlet valve being configured to direct hydraulic fluid from the actuator-side port to the wheel cylinder via the at least one brake-side port when the inlet valve is in the open condition. An outlet valve is positioned in the body and operable between an open condition and a closed condition, the outlet valve being configured, when in the open condition, to relieve hydraulic fluid from the wheel cylinder via the at least one brake-side port. An accumulator is fluidly coupled with the outlet valve to receive hydraulic fluid relieved from the wheel cylinder by the outlet valve. The accumulator includes a bore formed in the body and having first and second ends, an orifice formed in the body in fluid communication with the bore and positioned at a first end of the bore, and a closure sealingly engaged with the second end of the bore. A piston is positioned in the bore and forms a seal therewith, the piston being movable within the bore along an axis defined thereby and dividing the bore into first and second variable volume chambers. The accumulator includes a first permanent magnet and at least one magnetically-responsive element configured to cooperate with the first permanent magnet to magnetically bias the piston toward the first end of the bore.

In yet another aspect, the invention provides a method of assembling hydraulic accumulators. A first block is provided having a first bore, a first orifice in communication with a first end of the first bore, and an open end opposite the first end. A second block is provided having a second bore, a second orifice in communication with a first end of the second bore, and an open end opposite the first end of the second bore, the second bore being substantially identical to the first bore. First and second substantially identical pistons are provided. The first piston is inserted into the first bore, and the second piston is inserted into the second bore. First and second substantially identical closures are provided, and the first and second closures are coupled with the open ends of the respective first and second bores. A first ferromagnetic pair is provided, at least a part of which is coupled to the first piston, the first ferromagnetic pair biasing the first piston toward the first end of the first bore so that the first piston is allowed to travel a first distance from the first end of the first bore when hydraulic fluid of a predetermined pressure is present at the first orifice. A second ferromagnetic pair is provided, at least a part of which is coupled to the second piston, the second ferromagnetic pair biasing the second piston toward the first end of the second bore so that the second piston is allowed to travel a second distance, greater than the first distance, from the first end of the second bore when hydraulic fluid of the predetermined pressure is present at the second orifice.

Other aspects of the invention will become apparent by consideration of the detailed description and accompanying drawings.

### BRIEF DESCRIPTION OF THE DRAWINGS

FIG. 1 is a perspective view of an ABS unit schematically represented in a vehicle ABS system.

FIG. 2 is a schematic view of the ABS unit of FIG. 1.

FIG. 3 is an exploded assembly view of the ABS unit.

FIG. 4 is a cross-sectional view of a magnetic accumulator of the ABS unit.

FIGS. 5A-5C are cross-sectional views of three magnetic accumulators that are identical to each other except for having ferromagnetic pairs of increasing strengths, resulting in decreased volumetric capacities for a given pressure.

FIG. 6 is a cross-sectional view of a magnetic accumulator of another construction.

FIG. 7 is a cross-sectional view of a magnetic accumulator of yet another construction.

FIG. 8 is a cross-sectional view of a magnetic accumulator of yet another construction.

FIG. 9 is a cross-sectional view of a prior art spring accumulator of an ABS unit.

FIG. 10 is a cross-sectional view of another prior art spring accumulator having an extended spring and cap for increased capacity.

FIG. 11 is a cross-sectional view of another prior art spring accumulator having a modified piston shape for reduced capacity.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

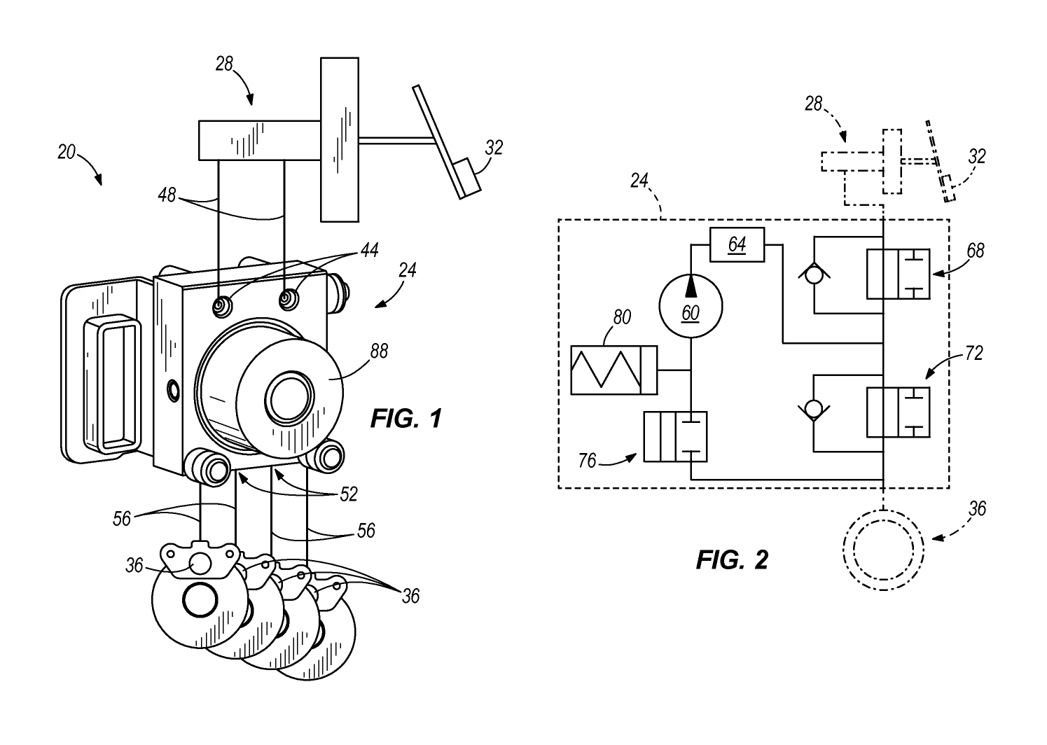

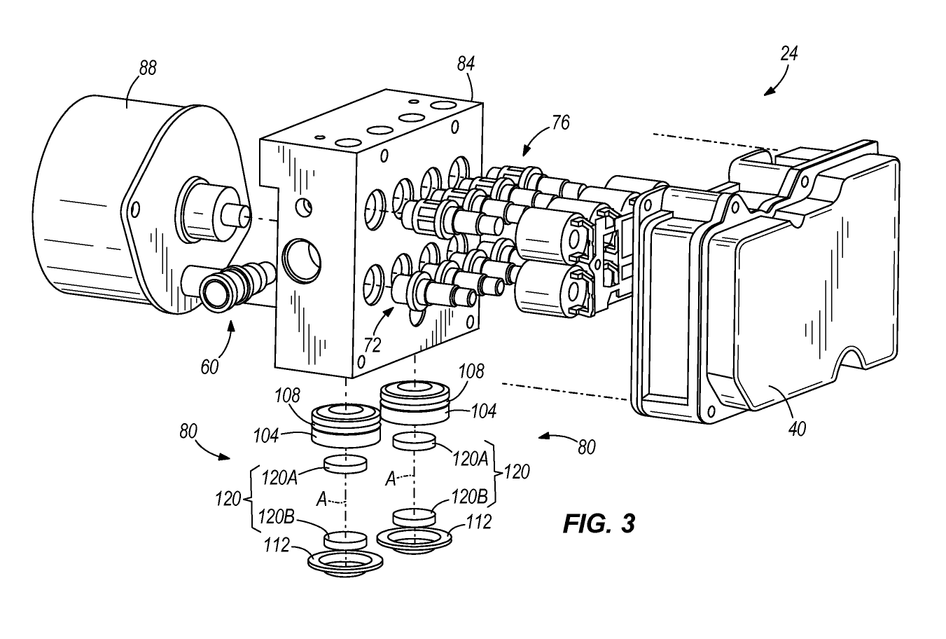

An anti-lock braking system 20 (ABS or ABS system) is shown in FIG. 1. The ABS system 20 is provided in a wheeled vehicle for preventing wheel lockup and skidding under hard braking events or braking on low friction surfaces. The ABS system 20 includes as its primary mechanical component a hydraulic unit 24 coupled between a brake master cylinder 28 (actuated by a user-operable brake pedal 32) and a plurality of wheel cylinders 36. Although the wheel cylinders 36 are shown in FIG. 1 as being incorporated with calipers of a disc braking system, other types of hydraulic braking systems may be provided at each of the wheels. The hydraulic unit 24 controls the selective relief of hydraulic fluid pressure from the wheel cylinders 36 so that a braking force just below the traction limit is maintained. A plurality of sensors (not shown) are coupled to a controller portion 40 (FIG. 3) of the hydraulic unit 24 to provide input information, typically regarding relative wheel speeds, so that the controller 40 can control the operation of the hydraulic unit 24. The hydraulic unit 24 may also be configured to provide brake force distribution and/or traction control as part of an overall electronic stability program (ESP) of the vehicle since many of the same hardware components are already provided by the ABS system 20.

The hydraulic unit 24 includes a pair of fluid ports 44 for communicating hydraulic fluid back and forth with the master cylinder 28 along two brake lines 48. Additional fluid ports 52 of the hydraulic unit 24 and individual brake lines 56 are also provided for each respective wheel cylinder 36 of the ABS system 20 so that hydraulic fluid can be exchanged back and forth between the hydraulic unit 24 and each individual wheel cylinder 36. The hydraulic unit 24 is shown in greater detail in FIGS. 2-4.

Along with the external brake lines 48, 56, the hydraulic unit 24 defines a fluid circuit between the master cylinder 28 and each of the wheel cylinders 36. As shown in FIG. 2, the following elements are provided in each fluid circuit of the hydraulic unit 24: a pump 60, a damper 64 (optionally eliminated or built into the pump 60), a suction control valve 68, an inlet valve 72, an outlet valve 76, and an accumulator 80. FIG. 2 is a basic schematic for one of the wheel cylinders 36, but it should be understood that components such as the inlet and outlet valves 72, 76 are individually provided for each wheel cylinder 36 as shown in FIG. 3, while other components may be shared among the circuits for the various wheel cylinders 36. For example, the hydraulic unit 24 of FIG. 3 (for the exemplary four wheel ABS system 20) includes a housing or body 84. The body 84 can be a one-piece cast or machined block, for example of aluminum, but other materials and multi-piece configurations are optional. A pump element 60 is received within the body 84. The pump element 60 is driven by a motor 88 coupled to the body 84. The body 84 also houses two accumulators 80. In the illustrated construction, each accumulator 80 is configured to receive hydraulic fluid from two of the wheel cylinders 36 through the respective outlet valves 76, but other configurations are optional.

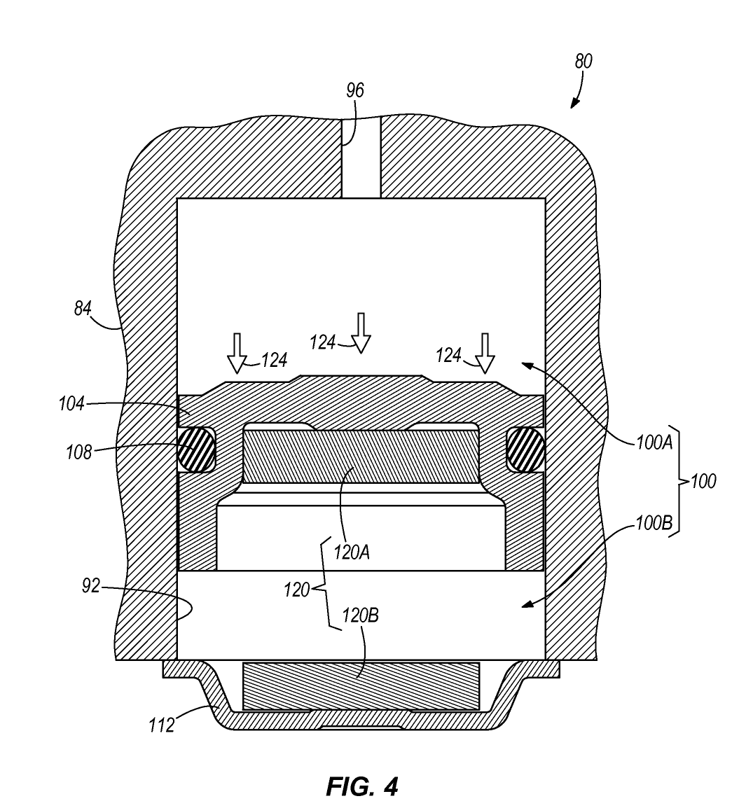

As shown in FIG. 4, each accumulator 80 includes a cavity or bore 92 in communication with an internal fluid conduit or orifice 96, both of which are formed in the body 84 in the illustrated construction. The bore 92 of each accumulator 80 is divided into two variable volume chambers 100, including a “wet” chamber 100A and a “dry” chamber 100B, by a piston 104 that is sealingly engaged with the bore 92. The piston 104 is movable back and forth within the bore 92 parallel to an axis A (FIG. 3), which is the axis defined by the bore 92. The piston 104 of the illustrated construction is provided with an external seal ring 108. A closure 112 (e.g., a cover or plug) is sealingly coupled to the block 84 and encloses the bore 92, defining an end of the “dry” chamber 100 and an end of the bore 92 as a whole. The end of the bore 92 receiving the closure 112 is opposite the end of the bore 92 in communication with the orifice 96.

Although the basic operation of the ABS system 20 will already be understood to one of ordinary skill in the art, it is briefly discussed below. When the brakes are actuated by the driver (via the pedal 32), hydraulic fluid is forced from the master cylinder 28 into the hydraulic unit 24 via the “actuator-side” ports 44. Hydraulic fluid is transmitted through the normally-open suction control valve 68 and the normally-open inlet valve 72 to the wheel cylinders 36 via the “brake-side” ports 52. The inlet valve 72 is operable between the open condition and a closed condition, which prevents excess pressure applied to the pedal 32 from being transmitted to the wheel cylinders 36. When the controller 40 determines that the brake-induced traction limit has been reached, the inlet valve(s) 72 are closed and the normally-closed outlet valve(s) 76 are opened to relieve hydraulic fluid from the wheel cylinder(s) 36 via the at least one brake-side port 52. The hydraulic fluid is directed into the corresponding accumulator 80 from which location it can later be pumped by the pump 60, through the damper 64 and the suction control valve 68, back to the master cylinder 28.

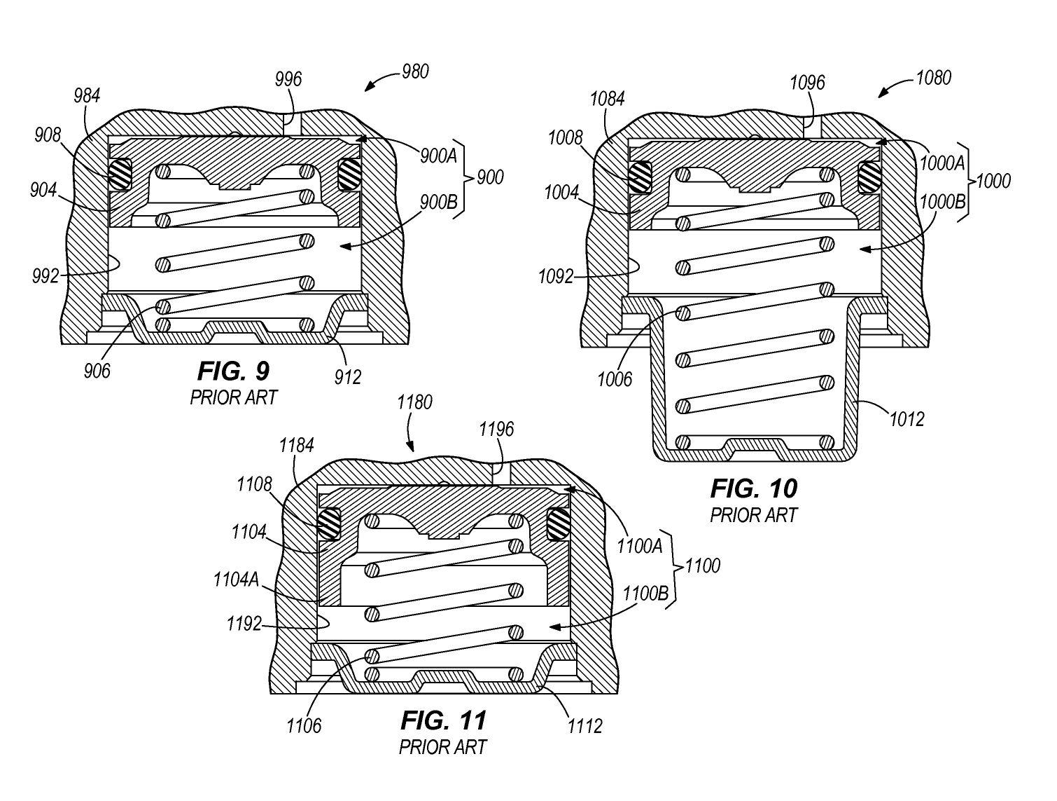

In order to accommodate the requirements for a variety of different vehicles, it is generally required that a supplier provide hydraulic unit variants with accumulators of various volumetric capacities. The volumetric capacity is defined as the resultant volumetric difference when the piston 104 is moved between an at-rest position (adjacent the end of the bore 92 in communication with the orifice 96) and a maximum displacement corresponding to a predetermined accumulator-full pressure. The volumetric capacity requirement will vary with vehicle weight and brake caliper size and elasticity. For example, the supplier's anti-lock braking scheme may specify predetermined values for opening pressure (i.e., the pressure at which the accumulator piston 104 begins to move from the at-rest position and accept fluid), accumulator-full pressure (i.e., the pressure at which the accumulator 80 reaches full fluid-receiving capacity), and return pressure (i.e., the pressure with which the piston 104 should return to the first end of the bore 92), but the accumulators for different vehicles, or even different sets of brakes within one vehicle, must often be tailored in size to ensure that they operate as desired at each of the specified predetermined pressure values. Conventionally, in order to provide the various volumetric capacities without modifying the body of the hydraulic unit, the bore diameter is kept constant while the stroke is customized by altering at least one of the piston, the spring, and the cover. An example of this is shown in FIGS. 9-11, in which most reference numbers are similar to those of FIG. 4 except that the figure number 9, 10, or 11 is used as a leading digit(s) along with the last two digits of each reference number from FIG. 4. The accumulator 980 of FIG. 9 utilizes a first piston 904, a first spring 906 and a first plug 912 to achieve a first volumetric capacity (at a predetermined accumulator-full pressure). The accumulator 1080 of FIG. 10 is varied from that of FIG. 9 by having an extended spring 1006 and plug 1012 to achieve a greater volumetric capacity than the first volumetric capacity of FIG. 9 (at the predetermined accumulator-full pressure). The accumulator 1180 of FIG. 11 is varied from that of FIG. 9 by having a piston 1104 with an elongated skirt 1104A to provide a reduced volumetric capacity compared to the first volumetric capacity of FIG. 9 (at the predetermined accumulator-full pressure). Although only three variants are shown in FIGS. 9-11, this is only exemplary, and it is noted that several variants of pistons, springs, and plugs resulting in a multitude of combinations may be required to meet the full gamut of vehicle needs. This strategy serves the need for various capacity accumulators but leads to a great multitude of different parts and part combinations, which complicates manufacturing, inventory, assembly, and service. The hydraulic units for a variety of vehicles can be made more easily customizable and more cost effective if a larger number of parts were shared among the different hydraulic unit variants.

Returning now to the hydraulic unit 24 of FIGS. 3 and 4, the accumulators 80 are magnetic accumulators in which the piston 104 of each accumulator 80 is biased solely via non-contact means (i.e., no springs or other elastic elements contact the piston 104). As shown in FIGS. 3 and 4, each accumulator 80 includes one ferromagnetic pair 120 for biasing the piston 104 toward the end of the bore 92 having the orifice 96. As defined herein, the term “ferromagnetic pair” is used to refer to any pair of elements having an intrinsic magnetic attraction or repulsion therebetween, as opposed to an induced, temporary magnetic field from an electric current. For example, the ferromagnetic pair 120 of FIGS. 3 and 4 includes a first element 120A coupled to the piston 104 (e.g., at least one of adhesively-bonded and assembled with an interference fit) to move therewith, and a second element 120B coupled to the closure 112, wherein both of the elements 120A, 120B are permanent magnets and the permanent magnets are oriented to have similar poles facing each other to generate a repulsion force therebetween. When pressurized hydraulic fluid is admitted into the accumulator chamber 100 via the orifice 96, as indicated by the arrows 124 in FIG. 4, the permanent magnet elements 120A, 120B are moved closer together, the magnetic repulsion force increasing as the distance between the elements 120A, 120B is reduced. The magnetic strength of the ferromagnetic pair 120 is selected to enable the accumulator 80 to receive a predetermined volume of hydraulic fluid at the accumulator-full pressure (“maximum design pressure”). As discussed further below, different configurations of a ferromagnetic pair may include only a single permanent magnet element paired with a ferromagnetic element, and furthermore, more than one ferromagnetic pair may be present in a single accumulator 80, so the construction of FIGS. 3 and 4 with a single pair of permanent magnet elements 120A, 120B should not be considered limiting.

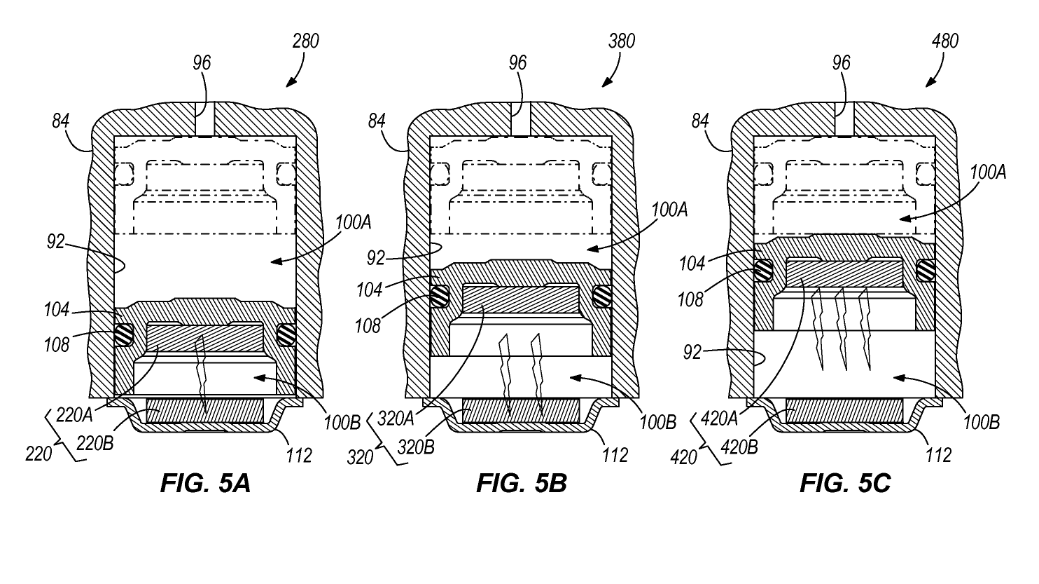

As described above, the magnetic strength of the ferromagnetic pair 120 is selected to correspond to the required accumulator capacity at a given accumulator-full pressure. Furthermore, a magnetic accumulator 80 of the type described and shown herein can be tailored or calibrated to use in a variety of ABS systems for different vehicles simply by changing out one or more of the elements 120A, 120B of the ferromagnetic pair 120 so that different predetermined volumes of hydraulic fluid corresponding to different vehicle requirements can be accommodated within the accumulator 80 at a particular accumulator-full pressure. This is illustrated by FIGS. 5A-5C, which show three accumulators 280, 380, 480 that are identical to each other except for having respective ferromagnetic pairs 220, 320, 420 of increasingly greater magnetic strength. In other words, the bores 92, pistons 104, seal rings 108, and closures 112 of each of the three accumulators 280, 380, 480 are identical, but the ferromagnetic pair 320 of the accumulator 380 of FIG. 5B provides a stronger magnetic repulsion force at a given spacing distance than the ferromagnetic pair 220 of the accumulator 280 of FIG. 5A, and the ferromagnetic pair 420 of the accumulator 480 of FIG. 5C provides a stronger magnetic repulsion force at a given spacing distance than the ferromagnetic pair 320 of the accumulator 380 of FIG. 5B. Correspondingly, each of the accumulators 280, 380, 480 of FIGS. 5A-5C is configured to provide a different accumulation volume or capacity. Illustrating this feature, the accumulators 280, 380, 480 are shown in operative conditions in which each accumulator is exposed to hydraulic fluid of a common predetermined accumulator-full pressure via the orifice 96. As shown by the solid line position of each respective piston 104, this results in a unique piston position and accumulator capacity. The phantom line position of the piston 104 of each accumulator 280, 380, 480 shows a common at-rest position. Although FIGS. 5A-5C illustrate three accumulators 280, 380, 480 with unique volumetric capacities for a particular accumulator-full pressure, in which the only dissimilar components are the elements of the ferromagnetic pairs 220, 320, 420, the variety is certainly not limited to these three versions. And furthermore, while the ferromagnetic pairs are compared in FIGS. 5A-5C as being used with a common accumulator-full pressure, accumulators with different strength ferromagnetic pairs or even two accumulators with the same strength ferromagnetic pairs may be configured or selected to perform in different ABS systems having different accumulator-full pressures. In any circumstance, the magnetic strength of the ferromagnetic pair is selected to provide a predetermined volumetric capacity corresponding to the vehicle's braking system when the accumulator is exposed to hydraulic fluid of a predetermined accumulator-full pressure.

The use of ferromagnetic pairs to bias the pistons in ABS hydraulic unit accumulators also yields an advantageous method of assembling multiple hydraulic accumulators having different volumetric capacities for a given hydraulic pressure (e.g., any two of the accumulators 280, 380, 480 shown in FIGS. 5A-5C). A first block is provided having a first bore, a first orifice in communication with a first end of the first bore, and an open end opposite the first end. A second block is provided having a second bore, a second orifice in communication with a first end of the second bore, and an open end opposite the first end of the second bore, the second bore being substantially identical to the first bore. First and second substantially identical pistons are provided. The first piston is inserted into the first bore, and the second piston is inserted into the second bore. First and second substantially identical closures are provided, and the first and second closures are coupled with the open ends of the respective first and second bores. A first ferromagnetic pair is provided, at least a part of which is coupled to the first piston, the first ferromagnetic pair biasing the first piston toward the first end of the first bore so that the first piston is allowed to travel a first distance from the first end of the first bore when hydraulic fluid of a predetermined pressure is present at the first orifice. A second ferromagnetic pair is provided, at least a part of which is coupled to the second piston, the second ferromagnetic pair biasing the second piston toward the first end of the second bore so that the second piston is allowed to travel a second distance, greater than the first distance, from the first end of the second bore when hydraulic fluid of the predetermined pressure is present at the second orifice.

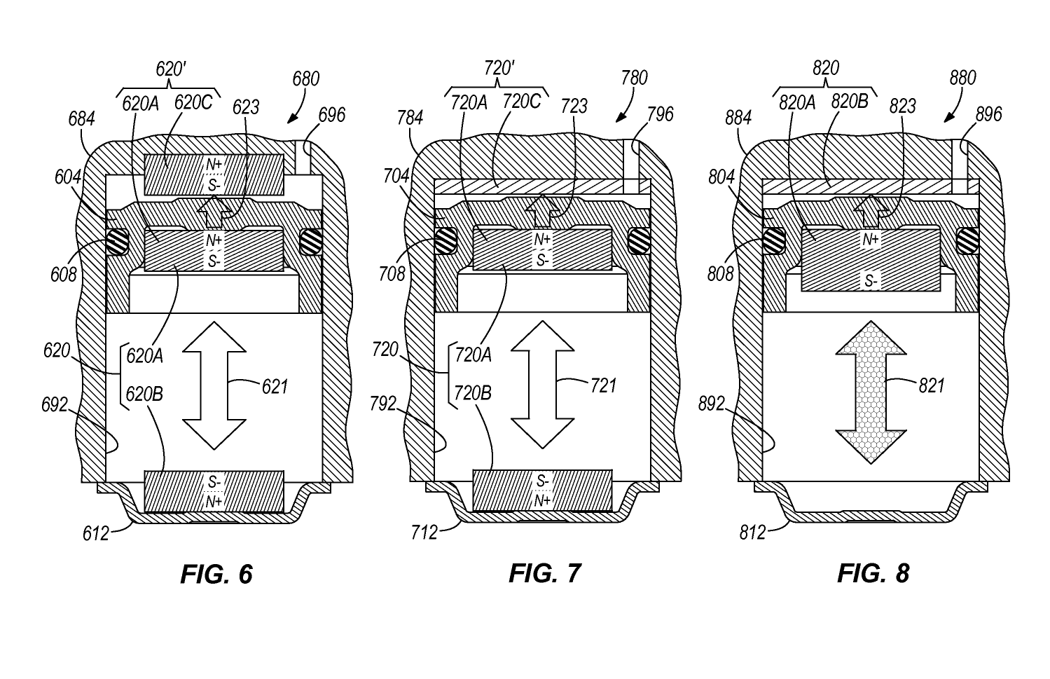

FIG. 6 illustrates another configuration for a magnetic accumulator 680. Most reference numbers are similar to those of FIG. 4 except that the figure number 6 is used as a leading digit along with the last two digits of each reference number from FIG. 4. The accumulator 680 includes a first ferromagnetic pair 620, including permanent magnet elements 620A, 620B, that is similar in construction to the ferromagnetic pair 120 already described above. In addition, the accumulator 680 includes a second ferromagnetic pair 620′ acting to provide a magnetic attractive force between the piston 604 and the first end of the bore 692 (the end having the orifice 696). The second ferromagnetic pair 620′ includes the first permanent magnet element 620A that is coupled to the piston 604 and a third permanent magnet element 620C that is positioned at the first end of the bore 692. The third permanent magnet element 620C is coupled to the first end of the bore 692 (e.g., with at least one of adhesive bonding and an interference fit). The third permanent magnet element 620C is oriented so that the pole facing the first permanent magnet element 620A is the opposing (attracting) pole. Thus, the piston 604 is magnetically “pushed” (arrow 621) by the second permanent magnet element 620B and magnetically “pulled” (arrow 623) by the third permanent magnet element 620C. By providing two ferromagnetic pairs instead of one, the magnetic biasing force provided by one pair will always increase as the magnetic biasing force provided by the other pair decreases.

FIG. 7 illustrates another configuration for a magnetic accumulator 780, in which two ferromagnetic pairs are provided. As described below, the accumulator 780 of FIG. 7 demonstrates that ferromagnetic pairs may include a permanent magnet element and any magnetically-responsive cooperating element (i.e., another permanent magnet or a ferromagnetic material responsive to the magnetic field of the permanent magnet). As used herein, a ferromagnetic material is a material exhibiting ferromagnetism, such as iron, cobalt, nickel, and some alloys or compounds, such as certain steels, containing one or more of these elements. Most reference numbers are similar to those of FIG. 4 except that the figure number 7 is used as a leading digit along with the last two digits of each reference number from FIG. 4. The accumulator 780 includes a first ferromagnetic pair 720, including permanent magnet elements 720A, 720B, that is similar in construction to the ferromagnetic pair 120 already described above. In addition, the accumulator 780 includes a second ferromagnetic pair 720′ acting to provide a magnetic attractive force between the piston 704 and the first end of the bore 792 (the end having the orifice 796). The second ferromagnetic pair 720′ includes the first permanent magnet element 720A that is coupled to the piston 704 and a third element 720C, a block or plate of ferromagnetic material, that is positioned at the first end of the bore 792. The ferromagnetic element 720C is coupled to the first end of the bore 792 (e.g., with at least one of adhesive bonding and an interference fit). Thus, the piston 704 is magnetically “pushed” (arrow 721) by the second permanent magnet element 720B and magnetically “pulled” (arrow 723) by the attraction between the first permanent magnet element 720A and the ferromagnetic element 720C. In the illustrated construction, the ferromagnetic element 720C spans the entire bore 792 and therefore, the orifice 796 is defined by registered apertures in both the body 784 and the ferromagnetic element 720C, but alternate configurations are optional. By providing two ferromagnetic pairs instead of one, the magnetic biasing force provided by one pair will always increase as the magnetic biasing force provided by the other pair decreases.

FIG. 8 illustrates another configuration for a magnetic accumulator 880. Most reference numbers are similar to those of FIG. 4 except that the figure number 8 is used as a leading digit along with the last two digits of each reference number from FIG. 4. The accumulator 880 includes a single ferromagnetic pair 820 acting to provide a magnetic attractive force between the piston 804 and the first end of the bore 892 (the end having the orifice 896). The ferromagnetic pair 820 includes a permanent magnet element 820A coupled to the piston 804 (e.g., with at least one of adhesive bonding and an interference fit) and a second element 820B, a block or plate of ferromagnetic material, that is positioned at the first end of the bore 892. The ferromagnetic element 820B is coupled to the first end of the bore 892 (e.g., with at least one of adhesive bonding and an interference fit). Thus, the piston 804 is magnetically “pulled” (arrow 823) by the ferromagnetic element 820B toward the first end of the bore 892. In addition to this magnetic biasing and to compensate for the deterioration of the magnetic attraction between the permanent magnet element 820A and the ferromagnetic element 820B with increased spacing therebetween, the accumulator 880 of FIG. 8 relies on an air spring effect (arrow 821) that results from the resistance of the air trapped between the piston 804 and the closure 812 to being compressed when the piston 804 moves toward the closure 812. In the illustrated construction, the ferromagnetic element 820B spans the entire bore 892 and therefore, the orifice 896 is defined by registered apertures in both the body 884 and the ferromagnetic element 820B, but alternate configurations are optional. Although the permanent magnet element 820A is coupled to the piston 804 and the ferromagnetic element 820B is coupled to the first end of the bore 892, these can be reversed without modifying the performance.

Additionally, although not illustrated, an accumulator may be constructed as a hybrid of the constructions of FIGS. 6 and 8 to include only one ferromagnetic pair provided by a first permanent magnet element coupled to the piston and a second permanent magnet element positioned at the first end of the bore (adjacent the orifice). The permanent magnet elements in this construction are oriented to attract each other to bias the piston toward the first end of the bore. As shown and described with reference to FIG. 8, an accumulator of this construction also relies on the air spring effect that results from the resistance of the air trapped between the piston and the closure to being compressed when the piston moves toward the closure.

Regardless of the particular configuration of magnet(s) and ferromagnetic element(s) in a magnetic accumulator according to any of the constructions described above (or combinations or modifications thereof), cost and performance benefits can be enjoyed. In addition to providing a single unified platform for vehicles requiring different accumulator capacities, the elimination of a contact-type (e.g., coil spring) biasing member prevents inherent shortcomings thereof, such as point loading between the piston and the spring wire, which can result in tilting of the piston and uneven compression and wearing of the piston, seal, and bore. In contrast, the accumulators of the present invention provide uniform biasing forces, distributed evenly across the piston.

Various features and advantages of the invention are set forth in the following claims.

What is claimed is:

1. An anti-lock braking hydraulic unit for a vehicle, the anti-lock braking hydraulic unit comprising:
a body including at least one actuator-side port configured to be fluidly coupled with a master cylinder, and at least one brake-side port configured to be fluidly coupled with a wheel cylinder of a braking device;
an inlet valve positioned in the body and operable between an open condition and a closed condition, the inlet valve being configured to direct hydraulic fluid from the actuator-side port to the wheel cylinder via the at least one brake-side port when the inlet valve is in the open condition;
an outlet valve positioned in the body and operable between an open condition and a closed condition, the outlet valve being configured, when in the open condition, to relieve hydraulic fluid from the wheel cylinder via the at least one brake-side port; and
an accumulator fluidly coupled with the outlet valve to receive hydraulic fluid relieved from the wheel cylinder by the outlet valve;
wherein the accumulator includes
a bore formed in the body, the bore defining an axis and having first and second ends,
an orifice formed in the body in fluid communication with the bore and positioned at a first end of the bore,
a closure sealingly engaged with the second end of the bore,
a piston positioned in the bore and forming a seal therewith, the piston being movable within the bore along the axis and dividing the bore into first and second variable volume chambers, and
at least one ferromagnetic pair magnetically biasing the piston toward the first end of the bore.

2. The anti-lock braking hydraulic unit of claim 1, wherein the at least one ferromagnetic pair includes a first permanent magnet coupled to the piston to move therewith.

3. The anti-lock braking hydraulic unit of claim 2, wherein the at least one ferromagnetic pair includes a second permanent magnet coupled to the closure, the first and second permanent magnets being oriented to repel each other.

4. The anti-lock braking hydraulic unit of claim 3, further comprising a third permanent magnet positioned adjacent the first end of the bore, the third permanent magnet oriented to attract the first permanent magnet.

5. The anti-lock braking hydraulic unit of claim 3, further comprising a ferromagnetic plate positioned adjacent the first end of the bore to provide a magnetic attraction between the piston and the first end of the bore via the first permanent magnet.

6. The anti-lock braking hydraulic unit of claim 2, the at least one ferromagnetic pair further comprising a ferromagnetic plate positioned adjacent the first end of the bore to provide a magnetic attraction between the piston and the first end of the bore via the first permanent magnet.

7. The anti-lock braking hydraulic unit of claim 2, the at least one ferromagnetic pair further comprising an additional permanent magnet positioned adjacent the first end of the bore, the additional permanent magnet oriented to attract the first permanent magnet.

8. The anti-lock braking hydraulic unit of claim 2, wherein the first permanent magnet is adhesively bonded to the piston.

9. The anti-lock braking hydraulic unit of claim 2, wherein the first permanent magnet has an interference fit with the piston.

10. The anti-lock braking hydraulic unit of claim 1, wherein the piston is solely non-contact-biased.

11. The anti-lock braking hydraulic unit of claim 1, wherein the body is an integrally-formed non-ferromagnetic block.

12. The anti-lock braking hydraulic unit of claim 1, wherein the first chamber is a wet chamber in fluid communication with the orifice, and the second chamber is a dry chamber sealed off from the orifice by the piston.

13. The anti-lock braking hydraulic unit of claim 1, wherein the accumulator is configured to receive a predetermined volume of hydraulic fluid into the first chamber at a maximum design pressure, the magnetic strength of the at least one ferromagnetic pair being selected to achieve the predetermined volume.

14. An anti-lock braking hydraulic unit for a vehicle, the anti-lock braking hydraulic unit comprising:
a body including at least one actuator-side port configured to be fluidly coupled with a master cylinder, and at least one brake-side port configured to be fluidly coupled with a wheel cylinder of a braking device;
an inlet valve positioned in the body and operable between an open condition and a closed condition, the inlet valve being configured to direct hydraulic fluid from the actuator-side port to the wheel cylinder via the at least one brake-side port when the inlet valve is in the open condition;
an outlet valve positioned in the body and operable between an open condition and a closed condition, the outlet valve being configured, when in the open condition, to relieve hydraulic fluid from the wheel cylinder via the at least one brake-side port; and
an accumulator fluidly coupled with the outlet valve to receive hydraulic fluid relieved from the wheel cylinder by the outlet valve;
wherein the accumulator includes
a bore formed in the body, the bore defining an axis and having first and second ends,
an orifice formed in the body in fluid communication with the bore and positioned at a first end of the bore,
a closure sealingly engaged with the second end of the bore,
a piston positioned in the bore and forming a seal therewith, the piston being movable within the bore along the axis and dividing the bore into first and second variable volume chambers, and
a first permanent magnet and at least one magnetically-responsive element configured to cooperate with the first permanent magnet to magnetically bias the piston toward the first end of the bore.

15. The anti-lock braking hydraulic unit of claim 14, wherein the first permanent magnet is coupled to the piston to move therewith.

16. The anti-lock braking hydraulic unit of claim 15, wherein the at least one magnetically-responsive element includes a second permanent magnet coupled to the closure, the first and second permanent magnets being oriented to repel each other.

17. The anti-lock braking hydraulic unit of claim 16, further comprising a third permanent magnet positioned adjacent the first end of the bore, the third permanent magnet oriented to attract the first permanent magnet.

18. The anti-lock braking hydraulic unit of claim 16, further comprising a ferromagnetic plate positioned adjacent the first end of the bore to provide a magnetic attraction between the piston and the first end of the bore via the first permanent magnet.

19. The anti-lock braking hydraulic unit of claim 15, wherein the at least one magnetically-responsive element includes a ferromagnetic plate positioned adjacent the first end of the bore to provide a magnetic attraction between the piston and the first end of the bore via the first permanent magnet.

20. The anti-lock braking hydraulic unit of claim 15, wherein the magnetically-responsive element is an additional permanent magnet positioned adjacent the first end of the bore, the additional permanent magnet oriented to attract the first permanent magnet.

21. The anti-lock braking hydraulic unit of claim 15, wherein the first permanent magnet is adhesively bonded to the piston.

22. The anti-lock braking hydraulic unit of claim 15, wherein the first permanent magnet has an interference fit with the piston.

23. The anti-lock braking hydraulic unit of claim 14, wherein the piston is solely non-contact-biased.

24. The anti-lock braking hydraulic unit of claim 14, wherein the accumulator is configured to receive a predetermined volume of hydraulic fluid into the first chamber at a maximum design pressure, the magnetic strength of the first permanent magnet and the at least one magnetically-responsive element being selected to achieve the predetermined volume.
